(19) United States
(12) Patent Application Publication
(10) Pub. No.: US 2002/0184234 A1
(43) Pub. Date: Dec. 5, 2002

(54) Internet-based patent and trademark applicaton management system

(76) Inventor: Steven W. Lundberg, Minneapolis, MN (US)

Correspondence Address: Schwegman, Lundberg, Woessner & Kluth, P.A., P.O.Box 2938, Minneapolis, MN, 55402, US

(21) Appl. No.: 09/872,701

(22) Filed: Jun. 1, 2001

(51) Int. Cl. G06F 17/00; G06F 15/16; G06F 7/00

(52) U.S. Cl. 707/104.1; 709/200

(57) ABSTRACT

A system for managing patent and trademark application data via the Internet, comprising matter, task, and security modules. The matter module is operable to manage data such as docketing data relating to patent matters, the tasks module is operable to manage tasks related to each matter managed by the matter module, and the security module is operable to restrict access to task and matter data management to selected system users. The system is implemented in some embodiments as a World Wide Web site on the Internet, which in further embodiments comprises various components such as an application server, a Java server, and a database.

### CLAIM OF PRIORITY

This application claims priority from the provisional application “Internet-Based Patent and Trademark Application Management System”; Steven W. Lundberg, Inventor; filed Mar. 29, 2001.

### FIELD OF THE INVENTION

The invention relates generally to managing patent and trademark applications, and more specifically to an internet-based system for management of patent and trademark applications.

### BACKGROUND OF THE INVENTION

Patent agents and attorneys that specialize in patent prosecution typically draft dozens of patent applications per year, and are engaged in prosecution of many more. Each of these must be carefully tracked by the patent attorney or legal assistant, so that important status information such as potential bar dates, deadlines for response to office action amendments and responses, and other data are not overlooked. Management of this data has historically been managed by inclusion of each item on a docket that is tracked on paper docketing calendars, or more recently using commercially available electronic docketing software that serves the same purpose as a calendar.

But, when multiple attorneys are involved in docketed matters for multiple clients, when complex client or legal rules must be applied, or when corporate clients wish to participate in the docket management of matters on a law firm or attorney's docket, docket management using paper calendars and simple docketing software can become labor-intensive and subject to errors. It is not uncommon for paper checklists of application drafting guidelines from clients, e-mail messages relating to a case, and multiple copies of docketing information to be kept separately for each patent or trademark application managed by an attorney or firm. Coordination and communication of this information is not a trivial task, and requires a significant amount of time and attention from the typical patent attorney or agent.

A system for managing patent and trademark applications and information related to these applications is desired, as well as a system to facilitate communication and coordination of this application-related information.

### SUMMARY OF THE INVENTION

A system for managing patent application data via the Internet, comprising matter, task, and security modules. The matter module is operable to manage data such as docketing data relating to patent matters, the tasks module is operable to manage tasks related to each matter managed by the matter module, and the security module is operable to restrict access to task and matter data management to selected system users. The system is implemented in some embodiments as a World Wide Web site on the Internet, which in further embodiments comprises various components such as an application server, a Java server, and a database.

### BRIEF DESCRIPTION OF THE FIGURES

FIG. 1 shows a web page from an Internet-based patent and trademark management system, consistent with an embodiment of the present invention.

FIG. 2 shows a messages web page, consistent with an embodiment of the present invention.

FIG. 3 shows a new tasks web page, consistent with an embodiment of the present invention.

FIG. 4 shows a new matters web page, consistent with an embodiment of the present invention.

FIG. 5 shows an organization view web page, consistent with an embodiment of the present invention.

FIG. 6 shows a templates web page, consistent with an embodiment of the present invention.

FIG. 7 shows an activities web page, consistent with an embodiment of the present invention.

FIG. 8 shows a user management web page, consistent with an embodiment of the present invention.

FIG. 9 shows a message list web page, consistent with an embodiment of the present invention.

FIG. 10 shows an activities web page, consistent with an embodiment of the present invention.

FIG. 11 shows an entities view web page for a selected matter, consistent with an embodiment of the present invention.

FIG. 12 shows an associated parties web page for a selected matter, consistent with an embodiment of the present invention.

FIG. 13 shows an IDS documents web page of data associated with a selected matter, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides a system for managing a docket of patent or trademark-related applications, and for coordinating and communicating such information among multiple parties involved in the patent or trademark application process.

The invention comprises in one embodiment a system for managing patent application data via the Internet, and comprises matter, task, and security modules. The matter module is operable to manage data such as docketing data relating to patent matters, the tasks module is operable to manage tasks related to each matter managed by the matter module, and the security module is operable to restrict access to task and matter data management to selected system users. The system is implemented in some embodiments as a World Wide Web site on the Internet, which in further embodiments comprises various components such as an application server, a Java server, and a database.

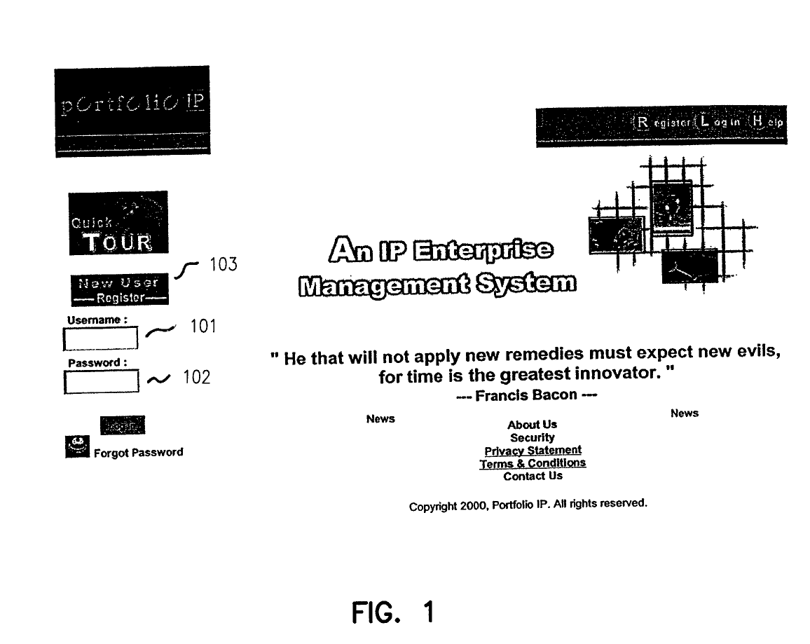

FIG. 1 illustrates one embodiment of a front World Wide Web (WWW) web page of a system consistent with the present invention. A user will log in to the example system shown here by entering a user name at 101, and a password at 102. If a prospective user does not have an account but wishes to create one, the user may do so by selecting to register at 103.

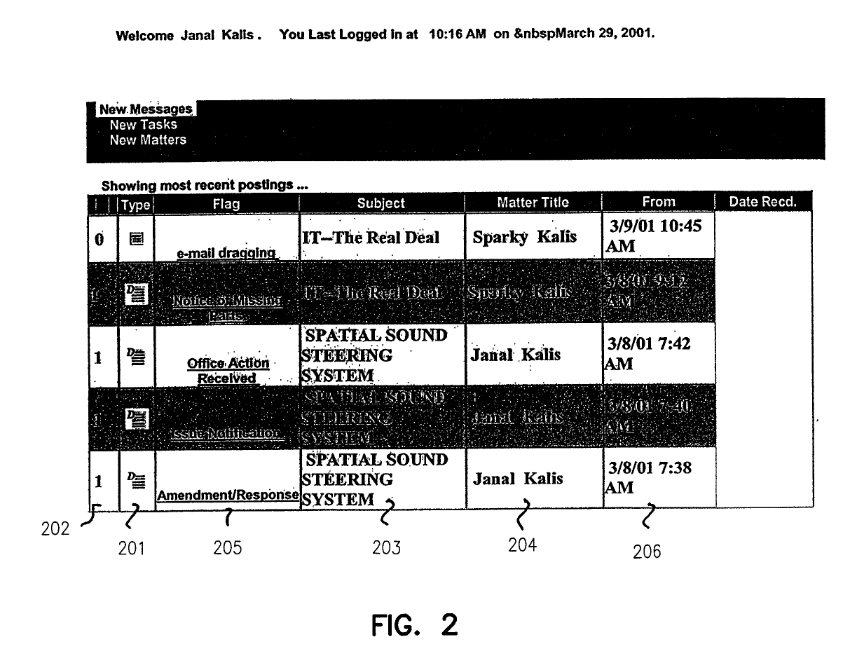

Upon logging in, the user is presented with a home screen presenting the user with various options. For example, the user may be presented with or may select to view his new messages, as is shown generally in FIG. 2. Each message as shown in FIG. 2 includes a message type represented by an icon at 201, an indication of the number of attachments to the message at 202, a matter title indicating a matter related to the message at 203, an indication of who the message is from at 204, a message title at 205, and the time and date the message was received at 206. The user may select a message to view the message, may select a user to send a reply message to the user, may select the message title to display the message, may select the number of attachments indicator to view the attachments, or may take other actions in response to the mew messages screen shown in FIG. 2.

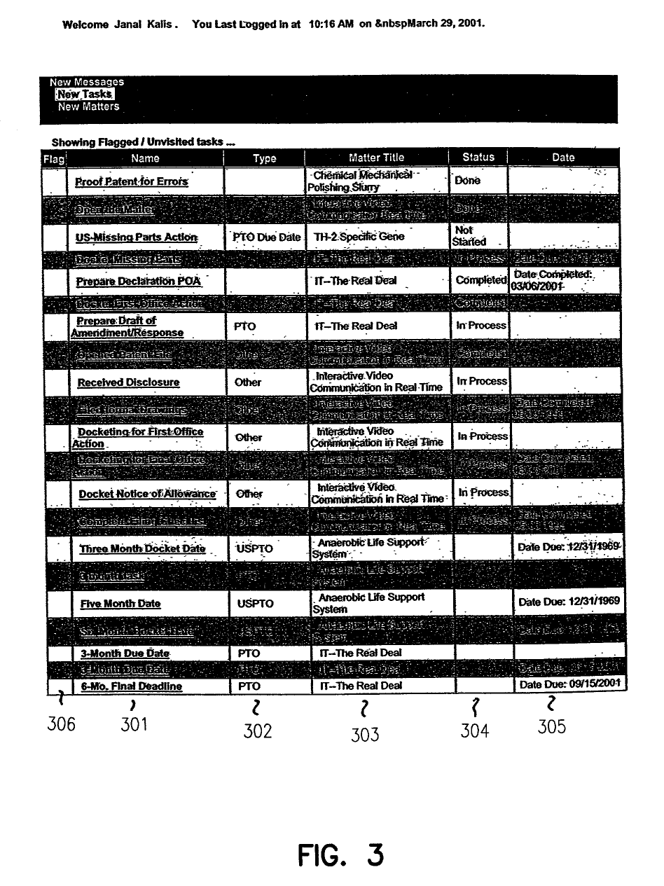

The user may also be presented with or select to view a new tasks screen as shown in FIG. 3, which illustrates new tasks associated with the particular logged in user. Each task has associated data that is displayed in the new tasks view, including the task name at 301, the type of task at 302, the title of the matter the task is related to at 303, the status of the task at 304, and a date associated with the task if appropriate at 305. Tasks may be flagged as shown at 306, so that a user may elect to view only flagged tasks or only new and flagged tasks, thereby viewing a subset of tasks that are of higher importance to the user.

In some embodiments of the invention, the user will be able to generate similar task lists, where the lists are limited to or sorted by client, by date due, by date completed, by status, by type, or by other similar criteria.

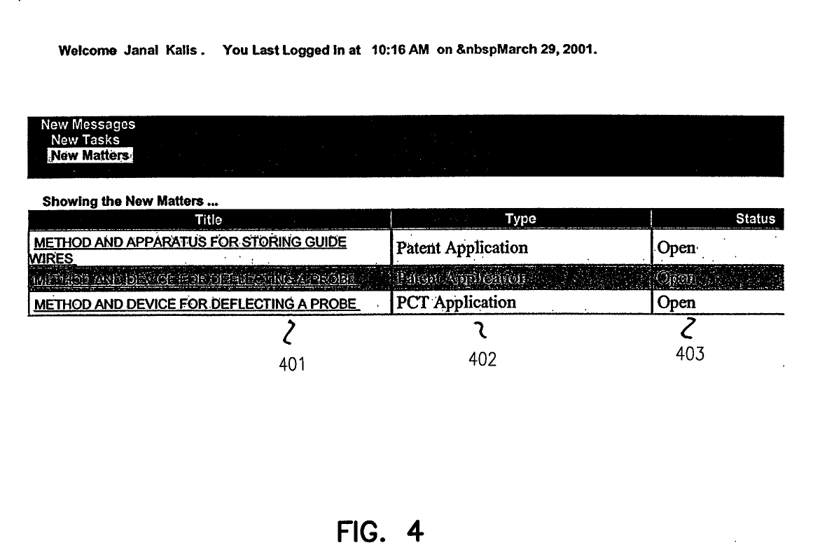

Users may also elect from the home page of the example embodiment of the invention described here to view new matters, as shown in FIG. 4. The title of each new matter is shown at 401, and the type of matter is shown at 402. The matter status is shown at 403, and additional matter material may be shown in further embodiments of the invention. As with tasks, users may also view in further embodiments of the invention other matter summary views similar to the one shown in FIG. 4, such as a view of all matters relating to a particular client, all matters with tasks due during a certain time period, all matters with a certain matter status, or any other such customized matter view.

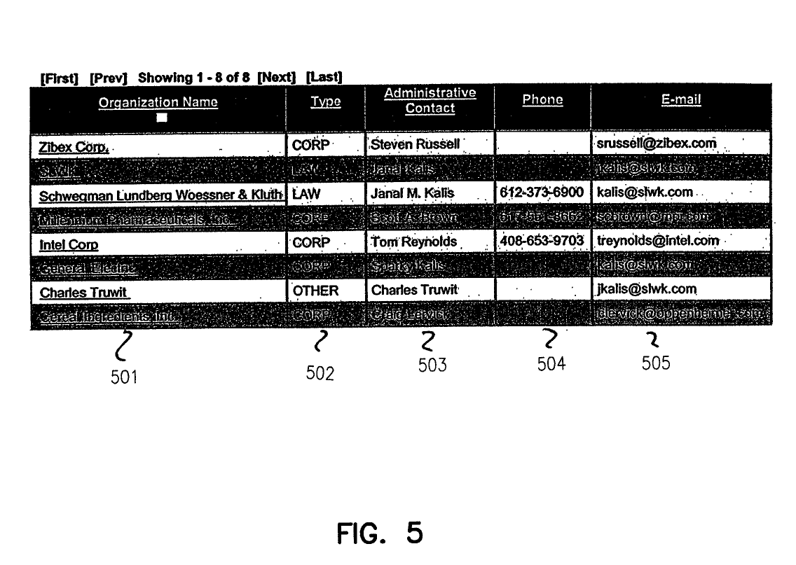

Matters and users may be associated in some embodiments of the invention with organizations, such as with particular client companies or particular law firms. These organizations are managed by the example embodiment of the system discussed here as is shown in FIG. 5. Each organization is identified by name as shown at 501, and has a type associated with it to identify the nature and role of the organization. The contact or agent for each organization is shown at 503, along with a contact phone number 504 and e-mail address 505 for each contact. Organization data may in some embodiments of the invention be edited or added only by system administrators, and in further embodiments select members who are part of an organization will be given authority to edit existing organization data.

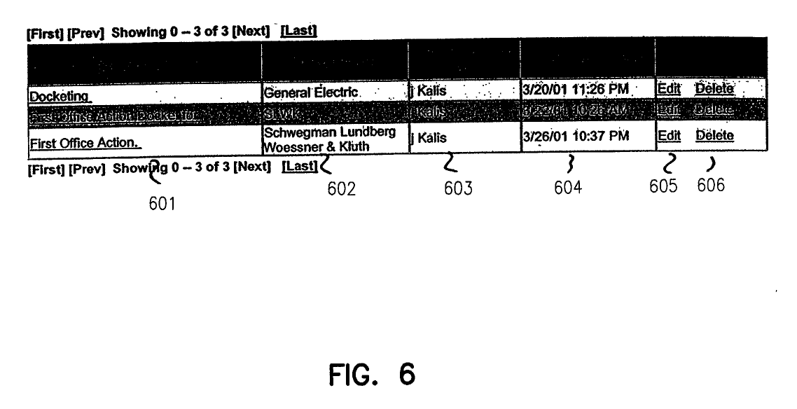

Tasks may be created for matters by manually entering tasks, or in some embodiments of the invention may further be created automatically via templates or other predefined task generation utilities. FIG. 6 illustrates a view of templates available for application to matters in one embodiment of the invention. The template name is shown at 601, and the organization associated with the template is shown at 602. The last modification of the template is reflected at 603 and 604, where the modifying user's identity and the date and time of the last modification are shown. The user has the option to delete existing templates as shown at 606, to create new templates, or to edit existing templates as shown at 605.

Templates include such items as creating checklists to ensure proper drafting criteria are met, creating tasks with associated dates such as deadlines for responses, and other similar tasks that are common to many applications and have predictable elements. For example, a client may request that a certain checklist of drafting criteria be completed before each filing, and the checklist may be implemented as a task associated with each of the client's matters via use of a template. Also, creation of docket dates and tasks associated with those dates in a system such as the present invention may be automatically calculated and created by a template, ensuring proper application of applicable rules. Many other such examples of tasks common to many applications with predictable elements exist, and all are within the scope of the template function as implemented in the example of the present invention presented here.

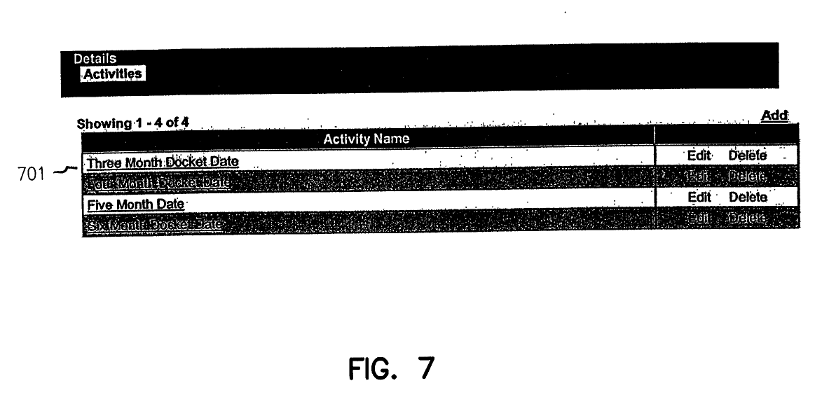

FIG. 7 illustrates the activities that are associated with an amendment and response to a typical United States Patent and Trademark Office issued Office Action. The typical shortened statutory three-month date for response is shown as an activity item at 701, and is followed by subsequent deadlines for taking each allowable extension of time past that date. These items will then automatically be added to the task list of each matter to which the template is applied, creating appropriate task entries for that matter.

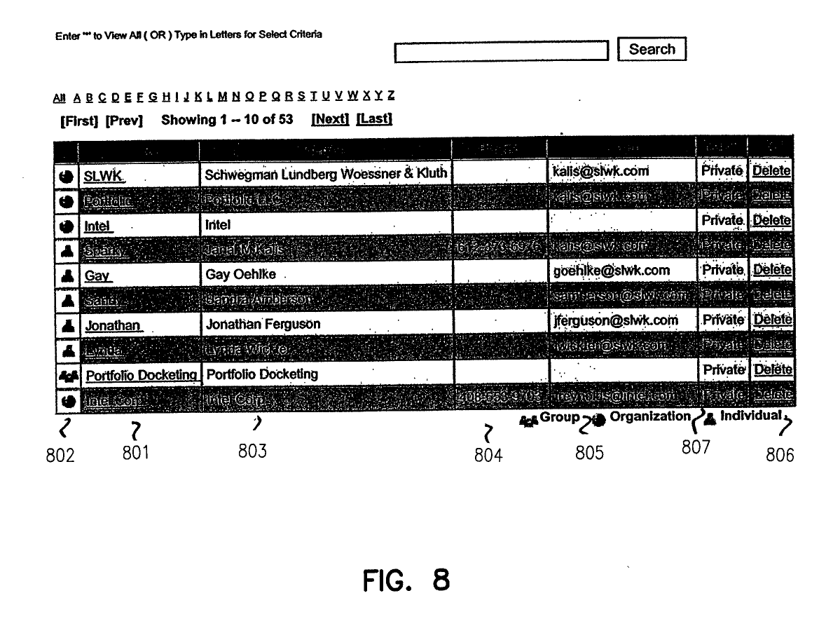

FIG. 8 illustrates a user management view of all users that have registered with the embodiment of the present invention described here. The user name or alias is shown at 801, the entity type is shown at 802, the full name of the entity is shown at 803, and contact information including phone and e-mail are shown at 804 and 805. The user management screen shown here allows a system administrator to delete users at 806, and indicates the source of the user at 807.

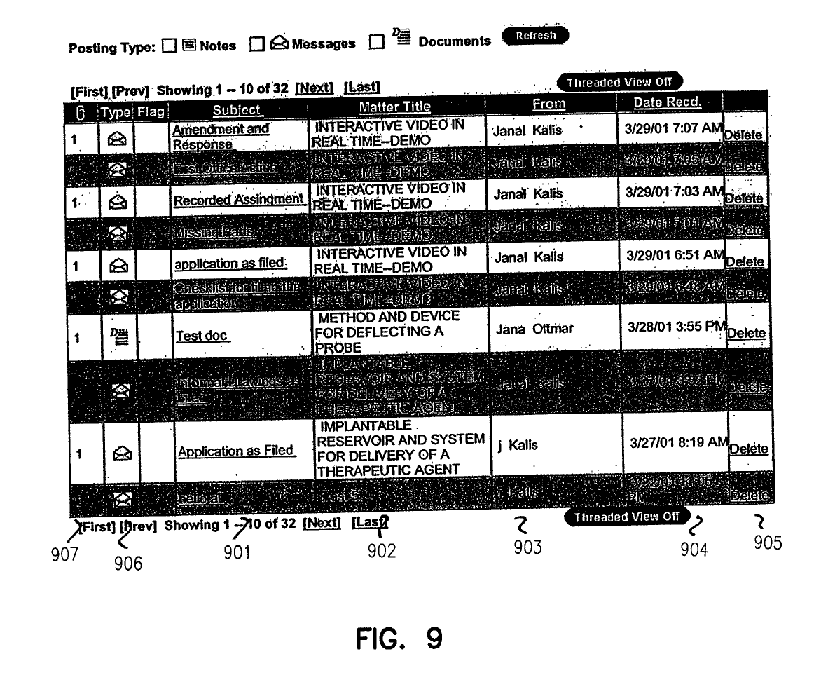

An example message list is shown in FIG. 9, which illustrates a variety of messages for a particular user. The subject or name of the message is shown at 901, and the title of the matter to which the message pertains is shown at 902. The sender of the message is shown at 903, and the date the message was received is shown at 904. At 905, the user is shown a Delete object that may be selected to delete the associated message. The type of message is indicated at 906, and the number of attachments to the message are shown at 907. Note that in this example, several automatically generated messages such as reports of actions completed or docket dates are shown in the message box.

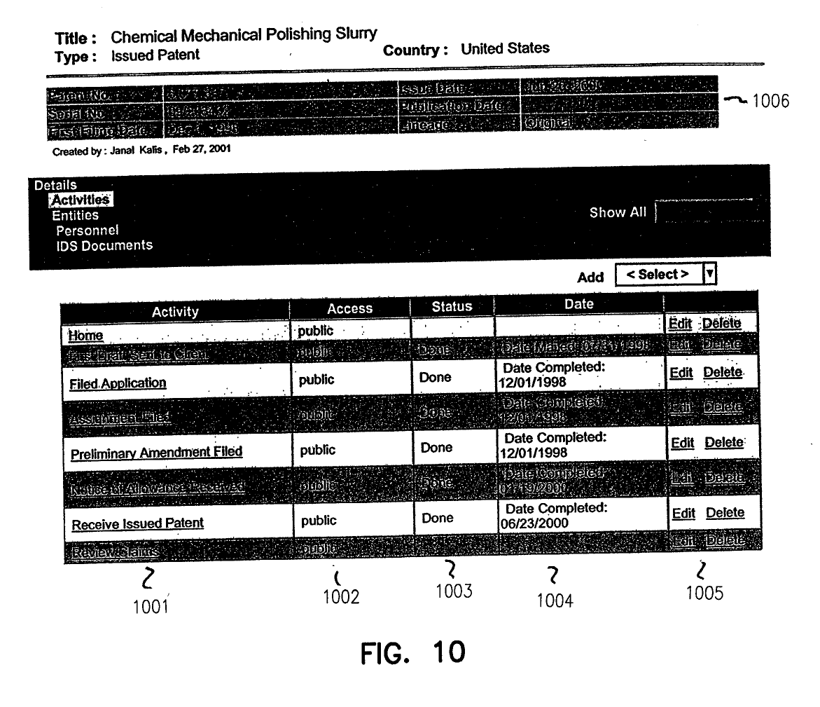

FIG. 10 shows a view of tasks or activities associated with a particular matter. The activity is shown at 1001, and is selectable by the user. Selecting the activity by name will open the detail list for that particular activity. Any restrictions on access to the activity are shown at 1002, and the status of the activity is shown at 1003. Relevant dates for the activity, which may vary in type depending on the activity status, are shown at 1004. At 1005, the user may edit or delete listed activities. Because the matter shown here is an issued patent, the patent number, issue date, and other information are known and are displayed at 1006 in a matter page header.

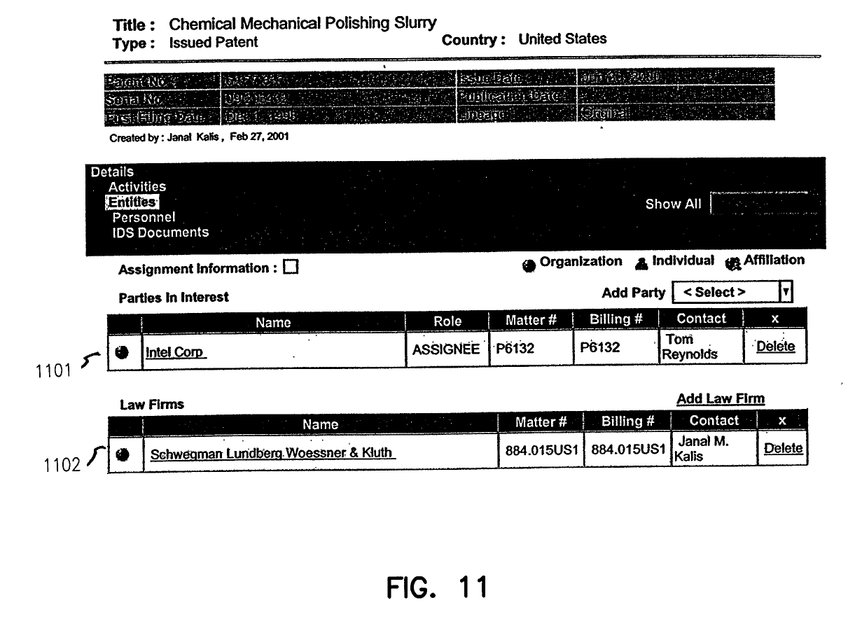

FIG. 11 shows an entities view of a particular selected matter. The parties in interest in this example comprise Intel Corp., as shown at 1101. The law firm associated with the matter is shown at 1102.

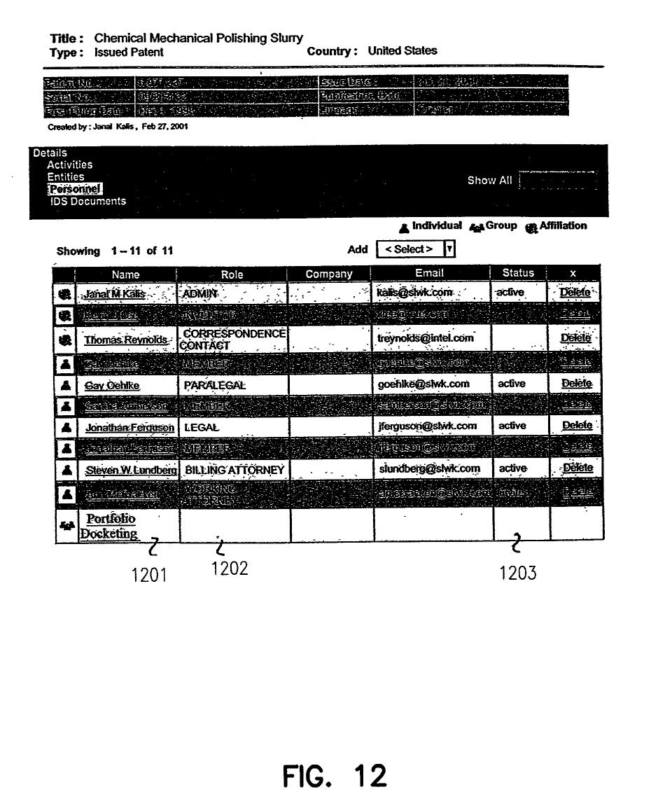

The embodiment of the invention shown here also shows additional associated parties, such as corporate counsel responsible for overseeing the matter, the attorney and paralegals involved with the case, and other users or entities involved with the matter. This is shown in FIG. 12, where the associated users are listed at 1201. The role each user has in the matter is shown at 1202, and the status of the user is shown at 1203. Note that a user may be invited to join a matter, but is not listed as active in this embodiment of the invention until the user takes affirmative steps to join in a matter.

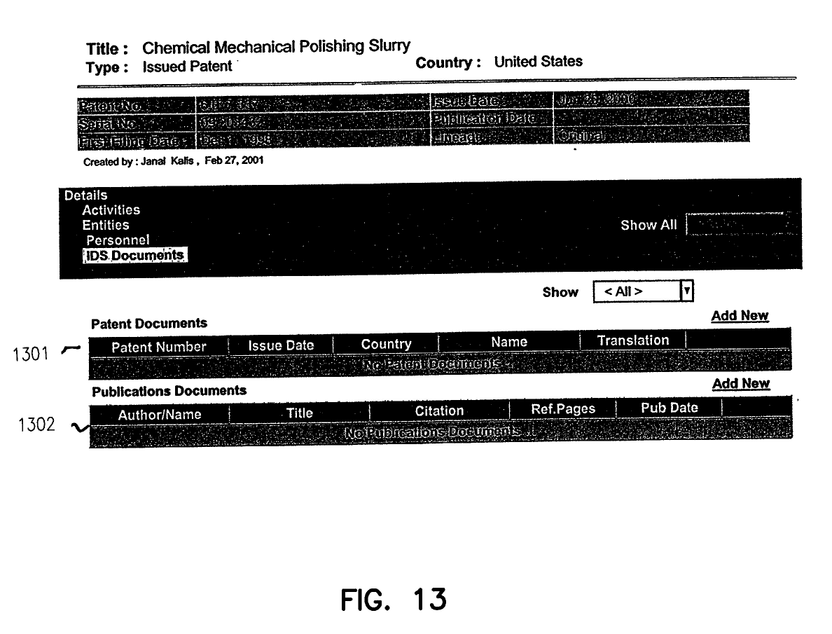

FIG. 13 is an IDS documents view of data associated with a matter, and shows documents that must be disclosed in an Information Disclosure Statement or IDS to the USPTO. Because no documents have been associated with this example matter, none are illustrated here. For patent documents that must be cited, the patent number, issue date, country of issue, name, and translation are shown at 1301. For documents that are not patent documents but are other publications, the author's name, document title, citation, referred pages, and publication date are recorded and are shown at 1302.

The example embodiment of the present invention explained above and in the figures is further described in attached Appendix 1. This appendix, entitled “PortfolioIP—Use Cases”, further describes ways in which the functionality of the present invention may be used by various users and organizations to facilitate more efficient management of a patent or trademark docket.

The second appendix, Appendix 2, discusses in much greater detail the way in which Information Disclosure Statement (IDS) management functionality is integrated into the example embodiment of the invention as discussed above, and more specifically as was described in FIG. 13 and the accompanying description.

The third appendix, a compact disc marked with the title and attorney docket number of this application, contains source code, web page code, and other code as will be understood by one skilled in the art to enable and more fully characterize the example embodiment of the present invention described herein. what the present invention provides

Although specific embodiments of the present invention have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A system for managing patent application data via the Internet, comprising:
a matter module, the matter module operable to manage data relating to patent matters, the managed data comprising docketing data;
a tasks module, the tasks module operable to manage tasks related to each matter managed by the matter module, the tasks comprising docketing tasks; and
a security module, the security module operable to restrict access to task and matter data management to selected system users.

2. The system of claim 1, wherein managing data relating to patent matters comprises creating new patent matter data.

3. The system of claim 1, wherein managing data relating to patent matters comprises retrieving patent matter data.

4. The system of claim 1, wherein managing data relating to patent matters comprises editing patent matter data.

5. The system of claim 1, wherein managing tasks related to managed matters comprises automated creation of tasks.

6. The system of claim 1, wherein managing tasks related to managed matters comprises user creation of tasks.

7. The system of claim 1, wherein managing tasks related to managed matters comprises retrieving tasks for a particular matter.

8. The system of claim 1, wherein managing tasks related to managed matters comprises retrieving tasks for a particular user.

9. The system of claim 1, wherein managing tasks related to managed matters comprises retrieving tasks for a particular organization.

10. The system of claim 1, wherein managing tasks related to managed matters comprises editing tasks.

11. The system of claim 1, wherein managing tasks related to managed matters comprises viewing a calendar of tasks.

12. The system of claim 1, wherein the security module requires a user to log in before granting access to matter or task data, and wherein the security module further grants the logged in user access only to those matters and tasks to which the user has been granted access.

13. The system of claim 12, wherein users are granted access to matters and tasks by the creator of each matter or task.

14. The system of claim 1, further comprising a messaging module operable to provide messaging to users of the system.

15. The system of claim 14, wherein the messaging comprises automated messages to particular users, the messages relating to matters and tasks associated with the particular users.

16. The system of claim 14, wherein the messaging comprises a user sending messages to other users.

17. The system of claim 14, wherein the messaging module is further operable to send electronic mail (e-mail) to users, the e-mail comprising information relating to the user's role in managed tasks and matters.

18. The system of claim 1, wherein the system comprises a World-Wide Web site (Internet web site).

19. The system of claim 18, wherein the web site comprises application server pages.

20. The system of claim 18, wherein the web site comprises Java server pages.

21. The system of claim 18, wherein the system further comprises a database for managing patent application data.

22. The system of claim 21, wherein the system comprises multiple databases and is able to exchange data between the multiple databases.

23. The system of claim 22, the system further operable to synchronize data in the databases by publishing changes to one database to other associated databases within the system.

24. The system of claim 1, wherein multiple matters may be associated with each other, such that data relating to one of the multiple matters will be visible when viewing data relating to another of the multiple matters.

25. A machine-readable medium with instructions stored thereon, the instructions when executed operable to cause a computerized system to manage patent application data via the Internet by:
managing data relating to patent matters via a matter module, the managed data comprising docketing data;
managing tasks related to each matter managed by the matter module via a task module, the tasks comprising docketing tasks; and
restricting access to task and matter data management to selected system users via a security module.

26. The machine-readable medium of claim 25, wherein managing data relating to patent matters comprises creating new patent matter data.

27. The machine-readable medium of claim 25, wherein managing data relating to patent matters comprises retrieving patent matter data.

28. The machine-readable medium of claim 25, wherein managing data relating to patent matters comprises editing patent matter data.

29. The machine-readable medium of claim 25, wherein managing tasks related to managed matters comprises automated creation of tasks.

30. The machine-readable medium of claim 25, wherein managing tasks related to managed matters comprises user creation of tasks.

31. The machine-readable medium of claim 25, wherein managing tasks related to managed matters comprises retrieving tasks for a particular matter.

32. The machine-readable medium of claim 25, wherein managing tasks related to managed matters comprises retrieving tasks for a particular user.

33. The machine-readable medium of claim 25, wherein managing tasks related to managed matters comprises retrieving tasks for a particular organization.

34. The machine-readable medium of claim 25, wherein managing tasks related to managed matters comprises editing tasks.

35. The machine-readable medium of claim 25, wherein managing tasks related to managed matters comprises viewing a calendar of tasks.

36. The machine-readable medium of claim 25, wherein the security module requires a user to log in before granting access to matter or task data, and wherein the security module further grants the logged in user access only to those matters and tasks to which the user has been granted access.

37. The machine-readable medium of claim 36, wherein users are granted access to matters and tasks by the creator of each matter or task.

38. The machine-readable medium of claim 25, further comprising a messaging module operable to provide messaging to users of the system.

39. The machine-readable medium of claim 38, wherein the messaging comprises automated messages to particular users, the messages relating to matters and tasks associated with the particular users.

40. The machine-readable medium of claim 38, wherein the messaging comprises a user sending messages to other users.

41. The machine-readable medium of claim 38, wherein the messaging module is further operable to send electronic mail (e-mail) to users, the e-mail comprising information relating to the user's role in managed tasks and matters.

42. The machine-readable medium of claim 25, wherein the system comprises a World-Wide Web site (Internet web site).

43. The machine-readable medium of claim 42, wherein the web site comprises application server pages.

44. The machine-readable medium of claim 42, wherein the web site comprises Java server pages.

45. The machine-readable medium of claim 42, wherein the system further comprises a database for managing patent application data.

46. The machine-readable medium of claim 45, wherein the system comprises multiple databases and is able to exchange data between the multiple databases.

47. The machine-readable medium of claim 46, the instructions further operable to synchronize data in the databases by publishing changes to one database to other associated databases within the system.

48. The machine-readable medium of claim 25, wherein multiple matters may be associated with each other, such that data relating to one of the multiple matters will be visible when viewing data relating to another of the multiple matters.

49. A system for managing trademark application data via the Internet, comprising:
a matter module, the matter module operable to manage data relating to trademark matters, the managed data comprising docketing data;
a tasks module, the tasks module operable to manage tasks related to each matter managed by the matter module, the tasks comprising docketing tasks; and
a security module, the security module operable to restrict access to task and matter data management to selected system users.

50. The system of claim 49, wherein managing data relating to trademark matters comprises creating new trademark matter data.

51. The system of claim 49, wherein managing data relating to trademark matters comprises retrieving trademark matter data.

52. The system of claim 49, wherein managing data relating to trademark matters comprises editing trademark matter data.

53. The system of claim 49, wherein managing tasks related to managed matters comprises automated creation of tasks.

54. The system of claim 49, wherein managing tasks related to managed matters comprises user creation of tasks.

55. The system of claim 49, wherein managing tasks related to managed matters comprises retrieving tasks for a particular matter.

56. The system of claim 49, wherein managing tasks related to managed matters comprises retrieving tasks for a particular user.

57. The system of claim 49, wherein managing tasks related to managed matters comprises retrieving tasks for a particular organization.

58. The system of claim 49, wherein managing tasks related to managed matters comprises editing tasks.

59. The system of claim 49, wherein managing tasks related to managed matters comprises viewing a calendar of tasks.

60. The system of claim 49, wherein the security module requires a user to log in before granting access to matter or task data, and wherein the security module further grants the logged in user access only to those matters and tasks to which the user has been granted access.

61. The system of claim 60, wherein users are granted access to matters and tasks by the creator of each matter or task.

62. The system of claim 49, further comprising a messaging module operable to provide messaging to users of the system.

63. The system of claim 62, wherein the messaging comprises automated messages to particular users, the messages relating to matters and tasks associated with the particular users.

64. The system of claim 62, wherein the messaging comprises a user sending messages to other users.

65. The system of claim 62, wherein the messaging module is further operable to send electronic mail (e-mail) to users, the e-mail comprising information relating to the user's role in managed tasks and matters.

66. The system of claim 49, wherein the system comprises a World-Wide Web site (Internet web site).

67. The system of claim 66, wherein the web site comprises application server pages.

68. The system of claim 66, wherein the web site comprises Java server pages.

69. The system of claim 66, wherein the system further comprises a database for managing trademark application data.

70. The system of claim 69, wherein the system comprises multiple databases and is able to exchange data between the multiple databases.

71. The system of claim 70, the system further operable to synchronize data in the databases by publishing changes to one database to other associated databases within the system.

72. The system of claim 49, wherein multiple matters may be associated with each other, such that data relating to one of the multiple matters will be visible when viewing data relating to another of the multiple matters.

73. A machine-readable medium with instructions stored thereon, the instructions when executed operable to cause a computerized system to manage trademark application data via the Internet by:
managing data relating to trademark matters via a matter module, the managed data comprising docketing data;
managing tasks related to each matter managed by the matter module via a task module, the tasks comprising docketing tasks; and
restricting access to task and matter data management to selected system users via a security module.

74. The machine-readable medium of claim 73, wherein managing data relating to trademark matters comprises creating new trademark matter data.

75. The machine-readable medium of claim 73, wherein managing data relating to trademark matters comprises retrieving trademark matter data.

76. The machine-readable medium of claim 73, wherein managing data relating to trademark matters comprises editing trademark matter data.

77. The machine-readable medium of claim 73, wherein managing tasks related to managed matters comprises automated creation of tasks.

78. The machine-readable medium of claim 73, wherein managing tasks related to managed matters comprises user creation of tasks.

79. The machine-readable medium of claim 73, wherein managing tasks related to managed matters comprises retrieving tasks for a particular matter.

80. The machine-readable medium of claim 73, wherein managing tasks related to managed matters comprises retrieving tasks for a particular user.

81. The machine-readable medium of claim 73, wherein managing tasks related to managed matters comprises retrieving tasks for a particular organization.

82. The machine-readable medium of claim 73, wherein managing tasks related to managed matters comprises editing tasks.

83. The machine-readable medium of claim 73, wherein managing tasks related to managed matters comprises viewing a calendar of tasks.

84. The machine-readable medium of claim 73, wherein the security module requires a user to log in before granting access to matter or task data, and wherein the security module further grants the logged in user access only to those matters and tasks to which the user has been granted access.

85. The machine-readable medium of claim 84, wherein users are granted access to matters and tasks by the creator of each matter or task.

86. The machine-readable medium of claim 73, further comprising a messaging module operable to provide messaging to users of the system.

87. The machine-readable medium of claim 86, wherein the messaging comprises automated messages to particular users, the messages relating to matters and tasks associated with the particular users.

88. The machine-readable medium of claim 86, wherein the messaging comprises a user sending messages to other users.

89. The machine-readable medium of claim 86, wherein the messaging module is further operable to send electronic mail (e-mail) to users, the e-mail comprising information relating to the user's role in managed tasks and matters.

90. The machine-readable medium of claim 73, wherein the system comprises a World-Wide Web site (Internet web site).

91. The machine-readable medium of claim 90, wherein the web site comprises application server pages.

92. The machine-readable medium of claim 90, wherein the web site comprises Java server pages.

93. The machine-readable medium of claim 90, wherein the system further comprises a database for managing trademark application data.

94. The machine-readable medium of claim 93, wherein the system comprises multiple databases and is able to exchange data between the multiple databases.

95. The machine-readable medium of claim 94, the instructions further operable to synchronize data in the databases by publishing changes to one database to other associated databases within the system.

96. The machine-readable medium of claim 73, wherein multiple matters may be associated with each other, such that data relating to one of the multiple matters will be visible when viewing data relating to another of the multiple matters.
